(19) United States
(12) Patent Application Publication
(10) Pub. No.: US 2004/0131177 A1
(43) Pub. Date: Jul. 8, 2004

(54) Integrated telephony controller and method for performing auxiliary functions in the same

(75) Inventor: Ted Rabenko, Duluth, GA (US)

Correspondence Address: Sterne Kessler Goldstein & Fox PLLC, 1100 New York Avenue NW Suite 600, Washington, DC, 20005-3934, US

(73) Assignee: Broadcom Corporation

(21) Appl. No.: 10/341,393

(22) Filed: Jan. 14, 2003

Related U.S. Application Data
(60) Provisional application No. 60/437,741, filed on Jan. 3, 2003.

(51) Int. Cl. H04M 1/00; H04M 9/00

(52) U.S. Cl. 379/387.02

(57) ABSTRACT

An integrated telephony controller circuit with the ability to perform auxiliary functions is disclosed. The invention consists of a coder-decoder circuit (CODEC) including at least one analog-to-digital converter (ADC), said CODEC being capable of sending and receiving telephony data signals; a multiplexer coupled to said ADC; and a receiving means for receiving an analog sense signal, said receiving means coupled to said multiplexer; wherein said multiplexer allows said telephony signals and said analog sense signal to share said ADC. This integrated circuit provides a state driven means to share the use of the ADC depending on whether the primary telephony function is active.

### CROSS-REFERENCE TO RELATED APPLICATIONS

This application claims the benefit of U.S. provisional application 60/437,741 entitled “Integrated Telephony Controller and Method for Performing Auxiliary Functions in the Same” filed Jan. 3, 2003, which is incorporated by reference herein.

### BACKGROUND OF THE INVENTION

1. Field of the Invention

The present invention is related to integrated telephony control circuits, and more specifically to the integration and performance of auxiliary functions therein.

2. Background Art

Integrated circuits for telephony control typically contain analog-to-digital converters, digital-to-analog converters, and a digital signal processor. This integrated circuit is designed to receive an analog voice signal and turn it into a digital signal for transmission. It also takes a received digital signal that represents a voice, and turns it back into an analog signal so that it can be heard on the telephone handset. This portion of the integrated circuit is commonly called a coder-decoder circuit, or a CODEC. The analog-to-digital converter that is used in this CODEC is typically a high end analog-to-digital converter. Such analog-to-digital converters are expensive because they take up a relatively large portion of the integrated chip area. Typically these analog-to-digital converters are only used when the phone is in operation. As such, that there is a significant amount of time where this analog-to-digital converter, and the rest of the CODEC, are not being used.

Today, traditional telephony functions are being integrated into a variety of networked systems. For instance, it is now common to have a telephony function integrated with one's personal computer. Such integration often relies on packet transmission technology. For example, Internet Protocol, which is used with both Cable Modem and Asymmetrical Digital Subscriber Loop (ADSL) technologies, is an example of packet transmission technology.

Additional functions surround the telephony function when it is integrated with such packet transmission technology. For example, many implementations of packet telephony include a battery as part of the Consumer Premises Equipment (CPE) for the purpose of maintaining service continuity during local power outages. This architecture is very different from traditional Plain Old Telephone Service (POTS) where power is centralized. Thus, with packet telephony services, the CPE must perform the battery monitoring function. Such monitoring must periodically evaluate the condition of the local battery and report to centralized monitoring functions, or to the subscriber, that the battery is in need of replacement. Another additional function that packet telephony equipment must support is remote line testing that periodically checks line continuity. These and other auxiliary functions also require the use of an analog-to-digital converter.

In the current state of the telephony arts, these auxiliary functions are typically centralized and support a large number of subscribers. Separate equipment, and hence separate circuitry, is used to accomplish these auxiliary functions. Packet telephony implementations, however, integrate these functions in the CPE for one or more local telephony lines. As such, there is a need to economize the use of integrated circuit resources thus reducing both the parts count, and the cost of the CPE.

It would be beneficial, in the packet telephony control arts, to have a single integrated circuit that combines the CODEC circuitry and its associated functions, with the above mentioned auxiliary functions such as a battery monitoring circuit and a line test circuit. Such auxiliary functions could make use of the analog-to-digital converter in the CODEC while the telephony function is not in use. What is needed, is the integration of these auxiliary functions onto a single telephony controller integrated circuit.

### SUMMARY OF THE INVENTION

The invention integrates auxiliary telephony functions associated with packet transmission technology, and the traditional CODEC circuitry associated with POTS technology, onto a single integrated circuit. The invention is implemented by adding a multiplexer and an additional pin to an existing CODEC circuit. Adding the multiplexer and an additional pin allows auxiliary analog sense signals to time share the analog-to-digital converter already used in the CODEC. Such an addition reduces parts count and cost by eliminating a separate, off chip, analog-to-digital converter. Moreover, the invention allows additional telephony lines to be easily added to an existing CPE that is using packet transmission technology.

### BRIEF DESCRIPTION OF THE DRAWINGS/FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an environment in which an embodiment of the present invention might be employed.

FIG. 2 illustrates how auxiliary functions were conventionally implemented.

FIG. 3 illustrates an embodiment of the present invention where auxiliary functions are integrated onto a basic telephony control circuit.

### DETAILED DESCRIPTION OF THE INVENTION

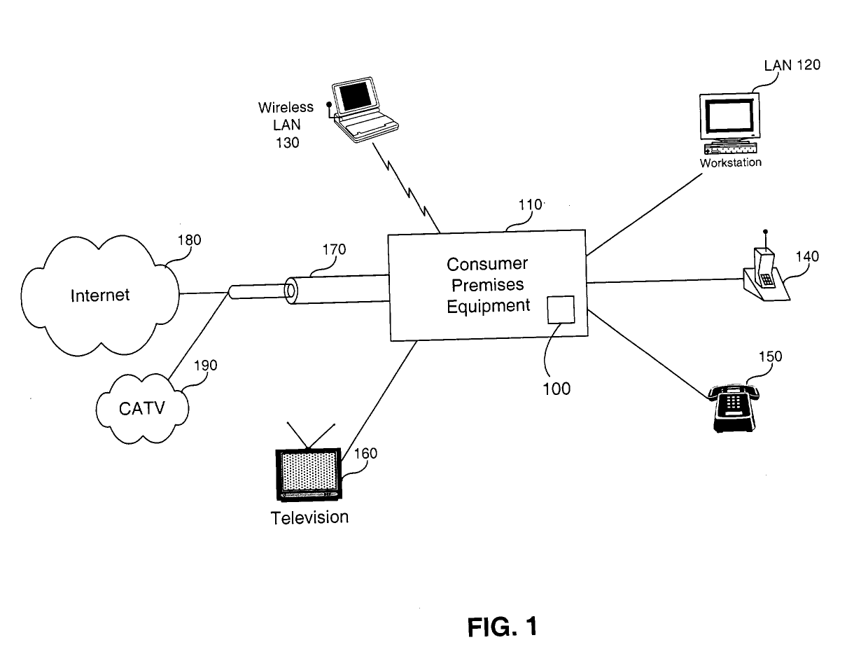

FIG. 1 illustrates an environment in which the present invention could be implemented. This environment consists of consumer premises equipment (CPE) 110, which is equipment that is provided by a manufacturer and is local to a consumer or subscriber. The CPE 110 may be used to integrate and control a local area network 120, a wireless local area network 130, a plurality of telephones 140, 150, and possibly a television 160. The CPE 110 uses packet transmission technology to allow various auxiliary equipment to communicate with each other, and with another network such as the internet 180. In an exemplary embodiment of the present invention, the integrated telephony control circuit 100 with its auxiliary functions can be integrated into the CPE 110, thus allowing the efficient addition of multiple telephony functions.

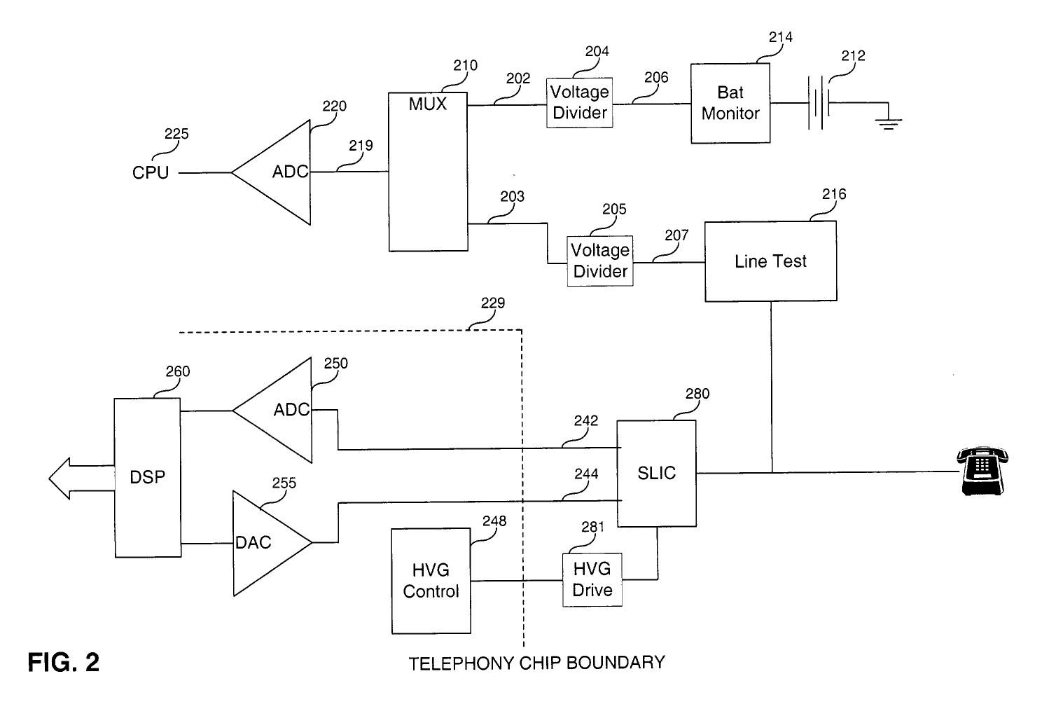

FIG. 2 illustrates how auxiliary functions associated with telephony control were conventionally implemented. The chip boundary line 229 separates a traditional coder/decoder circuit (CODEC) 230 from its off chip support equipment. The CODEC 230 in FIG. 2 contains a digital signal processor 260, an analog-to-digital converter 255, a digital-to-analog converter 250, and a high voltage control circuit 248. The off chip auxiliary functions include a subscriber line interface circuit (SLIC) 280, an HVG Drive circuit 281, a line test circuit 216, a battery 212 and a battery monitor circuit 214, a multiplexer 210, and an analog-to-digital converter 220. The SLIC 280 is a high voltage part that interfaces with the actual phone 140, 150. This circuit typically has a 75 volt ringing circuit, a 48 volt battery and a 24 volt talk circuit. The CODEC 230 typically operates at a much lower voltage, nominally between three to five volts. Different process technologies are used to build the CODEC 230 and the SLIC 280. For this reason, the SLIC 280 remains separate from the CODEC 230. The high voltage control circuit 248 provides a signal that controls the HVG Drive circuit 281 to provide the proper operating voltages for the external SLIC. The battery monitor circuit 214 and the line test circuit 216, also transmit a high voltage signal 206 and 207 that is translated by a voltage divider 204 and 205 to the low voltage analog sense signals 202, 203. A plurality of these auxiliary function sense signals are typically sent through a multiplexer 210, and then to a separate analog-to-digital converter 220. The digitized signals 219 are then sent to the central processing unit 225 and the CPE 110.

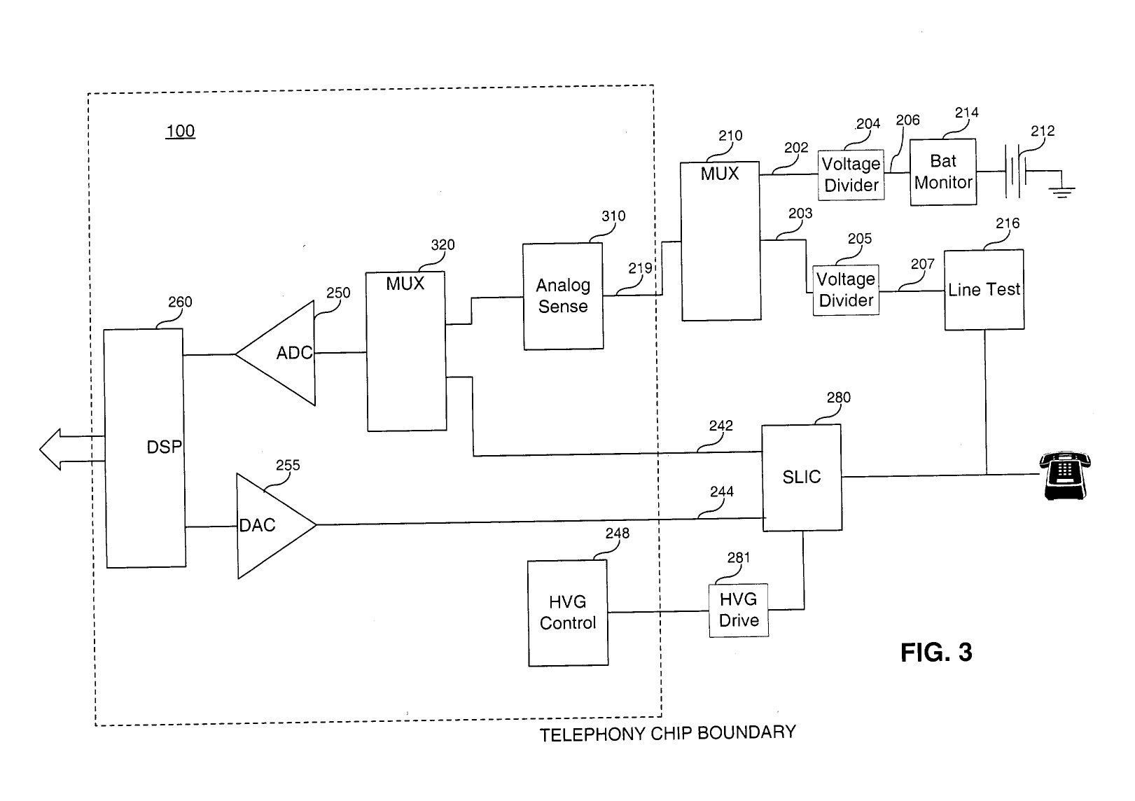

FIG. 3 illustrates one embodiment of the present invention where auxiliary function sense signals, such as the line test signal 202 and the battery monitor signal 203, are received onto the integrated telephony control circuit 100. The telephony control circuit 100 of the present invention includes a high voltage control 248, an analog sense circuit 310, a multiplexer 320, an analog-to-digital converter 250, a digital-to analog converter 255 and a digital signal processor 260. The addition of the analog sense interface 310 and the multiplexer 320 allows a plurality of auxiliary analog sense signals 219 to share the analog-to-digital converter 250 that was already present in the CODEC 230. The multiplexer 320 acts as a switch. Logic is provided for controlling the multiplexer based on the following state criteria. When the analog-to-digital converter 250 is being used for its primary function of digitizing analog voice signals 242, the analog sense signal 219 is blocked. When the CODEC portion of chip 100 is idle (e.g. when the phone is on the hook), then multiplexer 320 passes all analog sense signals 219 to analog-to-digital converter 250. It is presumed that auxiliary functions 214/216 may be implemented during the time when the primary function of ADC 250 is idle. Thus, the integrated circuit provides a state driven means to share the use of the ADC depending on whether the primary telephony function is active. The analog sense interface 310 is simply an additional hardwire pin connection and I/O circuitry which allows the analog sense signal 219 to be received on the chip.

Essentially, the addition of a relatively low cost multiplexer 320 and analog sense interface 310 allows the elimination of the previously off chip high cost analog-to-digital converter 220. Moreover, the integration of the multiplexer 320 and the analog interface 310 with the CODEC 230 allows for easier addition and implementation of additional telephony functions to the CPE 110.

### CONCLUSION

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. A telephony controller circuit, comprising:
a coder-decoder circuit (CODEC) including at least one analog-to-digital converter (ADC), said CODEC coupled to send and receive telephony signals;
a multiplexer coupled to said ADC; and
receiving means for receiving an analog sense signal, said receiving means coupled to said multiplexer;
wherein said CODEC and said multiplexer are disposed on the same integrated circuit; and
whereby said multiplexer allows said telephony signals and said analog sense signal to share said ADC.

2. The circuit of claim 1, wherein said receiving means can receive a plurality of analog sense signals.

3. The circuit of claim 2, wherein one of said plurality of analog sense signals is a battery status signal.

4. The circuit of claim 2, wherein one of said plurality of analog sense signals is a line test signal.

5. The circuit of claim 1, further comprising a digital signal processor coupled to said ADC.

6. A method for performing auxiliary functions in a telephony controller circuit, comprising:
a. receiving an analog sense signal;
b. receiving an analog voice signal;
c. multiplexing said analog sense signal with said analog voice signal; and
d. inputting said multiplexed signal to an analog-to-digital converter;
whereby said analog sense signal, and said analog voice signal share said analog-to-digital converter.

7. The method of claim 6, wherein said analog sense signal a battery status signal.

8. The method of claim 6, wherein said analog sense signal is a line test signal.

9. A telephony controller circuit, comprising:
an analog-to-digital converter (ADC) and a digital-to-analog converter (DAC);
a digital signal processor coupled to said ADC and to said DAC;
a means for sending an analog voice signal to an external telephone coupled to said DAC;
a multiplexer coupled to said ADC;
a means for receiving an analog voice signal coupled to said multiplexer; and
a means for receiving an analog sense signal coupled to said multiplexer;
whereby said analog sense signal and said analog voice signal share said ADC.

10. A method for performing auxiliary functions in a telephony controller circuit, comprising:
a. receiving an analog sense signal and an analog voice signal;
b. sensing a state condition that depends on whether said analog voice signal is present;
c. inputting said analog voice signal to an analog-to-digital converter (ADC) if said state condition indicates that said analog voice signal is present, while blocking said analog sense signal; and
d. inputting said analog sense signal to said ADC when said state condition indicates said analog voice signal is not present.
